(19) United States
(12) Patent Application Publication
(10) Pub. No.: US 2014/0313695 A1
(43) Pub. Date: Oct. 23, 2014

(54) LIGHT DIFFUSER AND BACKLIGHT MODULE HAVING SAME

(71) Applicant: Hon Hai Precision Industry Co., Ltd., New Taipei (TW)

(72) Inventor: Li-Ying WANG HE, Tu-Cheng (TW)

(73) Assignee: HON HAI PRECISION INDUSTRY CO., LTD., New Taipei (TW)

(21) Appl. No.: 14/252,920

(22) Filed: Apr. 15, 2014

(30) Foreign Application Priority Data
Apr. 18, 2013 (TW) 102113771

(51) Int. Cl. F21V 5/00; F21K 99/00

(52) U.S. Cl. CPC F21V 5/005; F21K 9/50
USPC 362/97.1; 362/355

(57) ABSTRACT

A light diffuser for a backlight module includes a main body, a diffusing micro-structure, and a micro-prism structure. The main body includes a light incident surface and a light emergent surface opposite to the light incident surface, the diffusing micro-structure is formed on the light incident surface, and the micro-prism structure is formed on the light emergent surface. The diffusing micro-structure includes a number of protrusions. The protrusions are substantially semi-cylindrical-shaped, and the prisms are substantially parallel to each other. The micro-prism structure includes a number of prisms, and the prisms are substantially parallel to each other.

### BACKGROUND

1. Technical Field

The present disclosure relates to light diffusers and backlight modules having the light diffusers, and particularly to a direct illumination-type backlight module and a light diffuser of the backlight module.

2. Description of Related Art

Backlight modules are used as illuminating devices for displays of electronic devices. A direct illumination-type backlight module typically includes a number of light sources and a light diffuser opposite to the light sources. The light sources are arranged as a matrix at a side of the light diffuser. However, because of the relative position relationship between the light diffuser and the light sources, particular portions of the light diffuser may receive less light of the light source than other portions of the light diffuser, therefore, dark areas will form on the light diffuser because of a non-uniformity intensity of light.

Therefore, what is needed is a light diffuser and a backlight module having the light diffuser addressing the limitations described.

### BRIEF DESCRIPTION OF THE DRAWING

The components of the drawing are not necessarily drawn to scale, the emphasis instead being placed upon clearly illustrating the principles of the embodiments of the present disclosure.

FIG. 1 is a cross sectional view of a backlight module taken along a first direction, according to an exemplary embodiment of the present disclosure, the backlight module including a light diffuser.

FIG. 2 is similar to FIG. 1, but showing a cross sectional view of the backlight module taken along a second direction substantially perpendicular to the first direction.

FIG. 3 is an isometric view of the light diffuser of FIG. 1.

### DETAILED DESCRIPTION

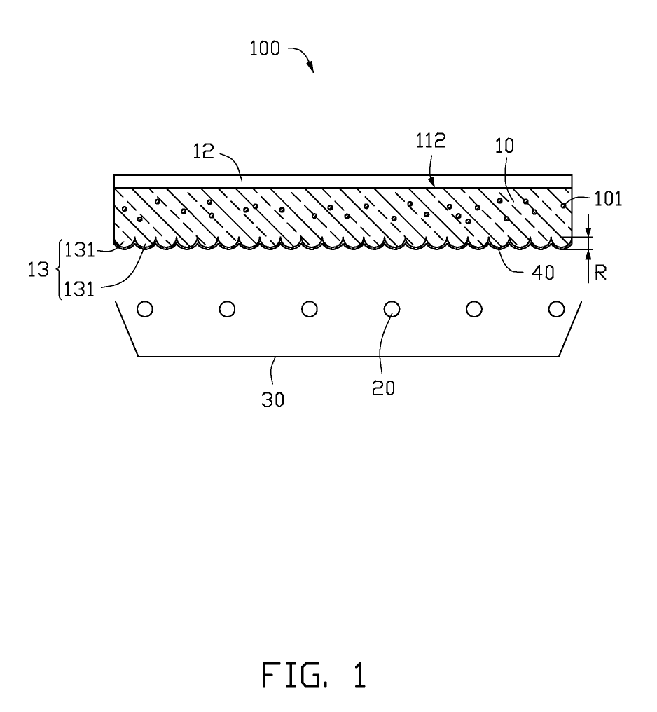

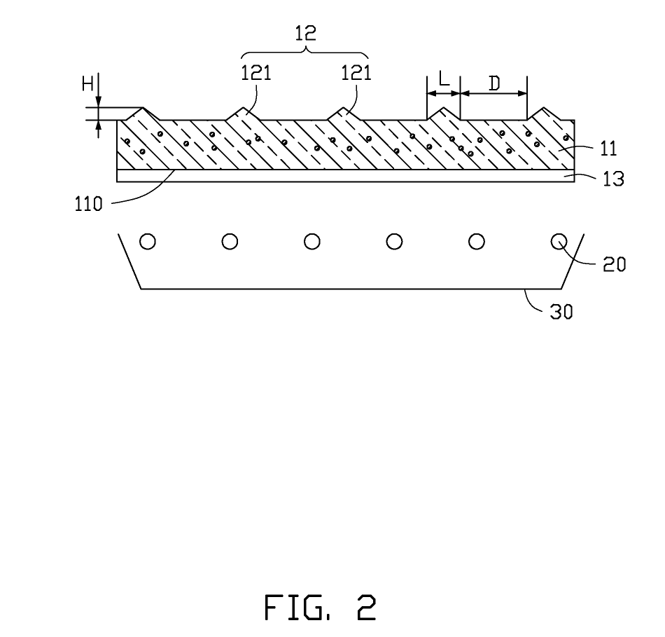

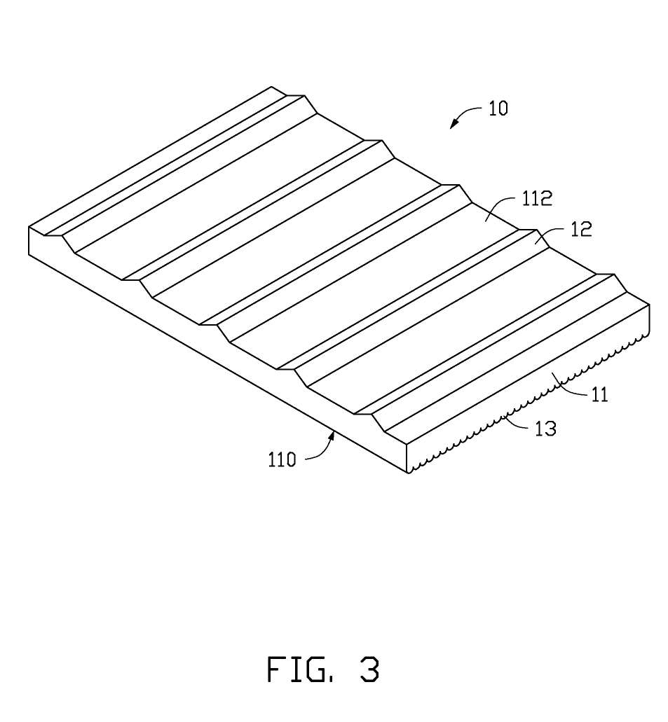

FIGS. 1-3 show a backlight module 100 of an exemplary embodiment of the present disclosure. The backlight module 100 includes a light diffuser 10, a number of light sources 20, and a reflector 30.

The light diffuser 10 includes a main body 11, a micro-prism structure 12 formed on a side of the main body 11, and a diffusing micro-structure 13 formed on another opposite side of the main body 11.

The main body 11 includes a light incident surface 110 and a light emergent surface 120 opposite to the light incident surface 110. The main body 10 is made of a transparent material. In detail, the material of the main body 11 can be polycarbonate (PC), polymethyl methacrylate (PMMA), methyl metharcrylate, styrene copolymer (MS), polyethylene glycol terephthalate (PETG), polystyrene(PS) or a mixture of two or more of the above materials. The main body 11 includes a number diffusing particles 101 dispersed in the main body 11. The diffusing particles 101 diffuse light as it is entering the main body 11. A material of the diffusing particles 101 can be silicon (Si), silicon dioxide (SiO₂), titanium dioxide (TiO₂), methyl metharcrylate, PMMA, MS, PS or a mixture of two or more of the above materials.

The micro-prism structure 12 is formed on the light emergent surface 112 of the main body 11. The micro-prism structure 12 is configured for optimizing emergent light to enhance a light diffusing efficiency of the light diffuser 10. The micro-prism structure 12 includes a number of prisms 121 arranged on the light emergent surface 112. In this embodiment, the prisms 121 are substantially parallel to each other, and a side surface of each prism 121 is coplanar with the light emergent surface 112. The prisms 121 have a same shape and size. Distances between adjacent prisms 121 along the light emergent surface 112 are the same. In detail, a cross section of each prism 121 is substantially isosceles triangular-shaped. A height H of a vertex of the cross section of the prism 121 away from the emergent surface 112 relative to the emergent surface 112 is about 0.05-0.2 millimeters. A length L of a side of the cross section of the prism 121 coplanar with the light emergent surface 112 is about 0.5-0.7 millimeters. The distance D between adjacent prisms 121 along the light emergent surface 112 is about 2.5-3.5 millimeters. In this embodiment, a value of H is 0.1 millimeters, a value of L is 0.6 millimeters, and a value of the D is 3 millimeters.

The diffusing micro-structure 13 is formed on the light incident surface 110. The diffusing micro-structure 13 includes a number of protrusions 131. Each protrusion 131 is substantially semi-cylindrical-shaped. A cross section of each protrusion 131 is substantially semi-circular-shaped, and a radius R of the cross section is about 0.4-0.6 millimeters. In this embodiment, a value of R is 0.5 millimeters. The protrusions 131 have a same shape and size. A length direction of the protrusions 131 is substantially perpendicular to a length direction of the prisms 121.

In this embodiment, adjacent protrusions 131 are connected to each other.

Alternatively, adjacent protrusions 131 can be spaced for a predetermined distance from each other.

The light sources 20 are positioned between the light diffuser 10 and the reflector 30. In this embodiment, the light sources 20 are light-emitting diodes (LEDs).

The reflector 30 is positioned at a side of the light sources 20 away from the light diffuser 10. The reflector 30 reflects light emitted by the light sources 20 to the light diffuser 10 to increase a utilization rate of light.

The backlight module 100 further includes an ultraviolet absorbent layer 40 formed on a light incident side of the light diffuser 10. The ultraviolet absorbent layer 40 absorbs ultraviolet portion of incident light, thus to keep the ultraviolet absorbent layer 40 from cracking and yellowing because of ultraviolet. The ultraviolet absorbent layer 40 is can be a type of diphenyl ketone ultraviolet absorbent, triazine ultraviolet absorbent, benzotriazole ultraviolet absorbent, or a mixture of two or more of the above ultraviolet absorbents.

In use, the light sources 20 emit light. A portion of the light directly projects on the light diffuser 10, and another portion of the light reflected to the light diffuser 10 by the reflector 30. Incident light is firstly diffused by the diffusing micro-structure 13 and further diffused by the diffusing particles 101, and then the light is optimized by the micro-prism structure 12 and emits from the light diffuser 10. In other words, light emitted from the backlight module 100 is diffused two times and optimized by the micro-prism structure 12. Therefore, a uniform intensity of the light is generated, dark areas on the light backlight module 100 is eliminated.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A light diffuser for a backlight module, comprising:
a main body comprising a light incident surface and a light emergent surface opposite to the light incident surface;
a diffusing micro-structure formed on the light incident surface, the diffusing micro-structure comprising a plurality of protrusions, the protrusions being substantially semi-cylindrical-shaped, and the prisms being substantially parallel to each other; and
a micro-prism structure formed on the light emergent surface, the micro-prism structure comprising a plurality of prisms, and the prisms being substantially parallel to each other.

2. The light diffuser of claim 1, wherein the main body comprises a number diffusing particles dispersed in the main body.

3. The light diffuser of claim 1, wherein a length direction of the protrusions is substantially perpendicular to a length direction of the prisms.

4. The light diffuser of claim 1, wherein a cross section of each prism is substantially isosceles triangular-shaped.

5. The light diffuser of claim 4, wherein a height of a vertex of the cross section of the prism away from the emergent surface relative to the emergent surface is in a range of 0.05-0.2 millimeters.

6. The light diffuser of claim 5, wherein the height of the vertex is 0.1 millimeters.

7. The light diffuser of claim 4, wherein a length of a side of the cross section of the prism coplanar with the light emergent surface is in a range of 0.5-0.7 millimeters.

8. The light diffuser of claim 7, wherein the length of the side is 0.6 millimeters.

9. The light diffuser of claim 4, wherein a distance between adjacent prisms along the light emergent surface is in a range of 2.5-3.5 millimeters.

10. The light diffuser of claim 9, wherein the distance is 3 millimeters.

11. The light diffuser of claim 1, wherein a cross section of each protrusion is substantially semi-circular-shaped, and a radius of the cross section is in a range of 0.4-0.6 millimeters.

12. The light diffuser of claim 11, wherein the radius is 0.5 millimeters.

13. The light diffuser of claim 1, wherein adjacent protrusions are connected to each other.

14. The light diffuser of claim 1, wherein the light diffuser comprises an ultraviolet absorbent layer formed on a light incident side of the light diffuser.

15. A backlight module, comprising:
a light diffuser, comprising:
a main body comprising a light incident surface and a light emergent surface opposite to the light incident surface;
a diffusing micro-structure formed on the light incident surface, the diffusing micro-structure comprising a plurality of protrusions, the protrusions being substantially semi-cylindrical-shaped, and the prisms being substantially parallel to each other; and
a micro-prism structure formed on the light emergent surface, the micro-prism structure comprising a plurality of prisms, and the prisms being substantially parallel to each other;
a plurality of light sources positioned at a light incident side of the light diffuser; and
a reflector positioned at a side of the light sources away from the light diffuser.
